(19) United States
(12) Patent Application Publication
(10) Pub. No.: US 2002/0074365 A1
(43) Pub. Date: Jun. 20, 2002

(54) Vented fluid container closure

(76) Inventor: John L. Young, Whittier, CA (US)

Correspondence Address: Thomas G. Pasternak, Esq., JENNER & BLOCK, ONE IBM PLAZA, CHICAGO, IL, 60611, US

(21) Appl. No.: 09/736,350

(22) Filed: Dec. 14, 2000

(51) Int. Cl. B67D 3/00; B67D 5/06

(52) U.S. Cl. 222/484; 222/525; 222/558

(57) ABSTRACT

A vented closure for sealing a fluid container which has a vent passage and a fluid passage in an annular collar and a cap which closes both.

### BACKGROUND OF THE INVENTION

1. Field of the Invention

The present invention relates generally to closures for fluid containers and, more particularly, to a closure for a fluid container that is vented and allows fluid to be drawn from the container without squeezing the container.

2. Discussion

Water and other non-carbonated beverages, and particularly sports drinks, are sold in individual servings in the form of plastic bottles. Such bottles typically have caps in the form of a pull open/push closed type closure, which typically provides a single fluid passage and thus is not vented. The lack of a vent in the closure causes the container to collapse as a consumer draws a beverage from the container while drinking, due to a pressure differential that is created between the fluid and the exterior of the container, the external pressure being higher as the exiting liquid causes internal pressure to decrease. At the same point during drinking process, depending on the size of the container, no additional liquid can be withdrawn from the container until the pressure is equalized by stopping the drinking process and allowing air to rush in through the single fluid passage in the closure. This equalization can cause a reflux or “backwash” from the consumer's mouth into the container, which tends to contaminate the fluid in the container. Because of this problem consumers frequently equalize pressure by holding the bottle away from the mouth and squeezing the bottle in a series of squirts, with pressure equalization taking place between each squirt. This procedure often results in spills of the fluid, and results in the consumer drinking less than he might if it were easier to dispense fluid.

Conventional fluid containers are sometimes vented, but the vent typically is part of the container itself, and not part of the closure. Other such systems require a flap valve or diaphragm to regulate the equalization pressure. A container is known that is designed for the specialized application of drinking while riding a bicycle, but is designed to allow the user to drink without tilting the head back. This device has a vent, but requires a flap valve and uses a straw to draw fluid from the bottom of the container. It is does not allow squirting. Such approaches are not adaptable to a standard beverage container and add a significant expense and complexity to the closure.

It is, therefore, one objective of the present invention to provide a vented fluid container closure that is adaptable to a standard beverage container.

It is another objective of the present invention to provide a vented fluid container closure that is easily manufactured and not complex.

It is a further objective of the present invention to solve the problem of contamination of fluid while drinking due to reflux.

It is yet another objective of the present invention to provide a vented closure that allows drawing of fluid out of the container without the container collapsing or reflux occurring.

It is still another objective of the present invention to provide a vented closure that allows the consumer to draw fluid by squirting if he so chooses.

### SUMMARY OF THE INVENTION

In order to achieve the foregoing objectives, the vented closure of the present invention provides a closure with a vent passage and a fluid passage in the same annular collar that are opened and closed by the same cap. When the cap is open, the fluid is drawn out via the fluid passage, and the vent passage prevents differential pressure from being created. The closure is designed to screw onto the threads at the top of a standard beverage container.

One embodiment of the present invention consists of a cap that engages an annular collar. The cap is movable along the collar between open and closed positions, and when in the open position, the vent passage and fluid passage are both open. When the cap is closed, the vent passage and the fluid passage are both closed. The first embodiment may also have an intermediate position for the cap, in which the vent passage is closed but the fluid passage is open, allowing the customer to “squirt” fluid from the container by squeezing the container, as is done with conventional closures, if he so chooses.

A second embodiment of the present invention consists of a U-shaped cap rotating about a raised center portion, with the vent formed on one side of the raised portion. In the second embodiment the top surface of the raised center portion, and corresponding surface of the cap may have the shape of rotation of the cap about the pivotal axis or ramped, and the cap may include resilient portions for improved sealing.

### BRIEF DESCRIPTION OF THE DRAWINGS

The operational features of the present invention are explained in more detail with reference to the following drawings, in which like reference numerals refer to like elements and in which:

FIG. 1 is an exploded front top perspective view of the first embodiment of the vented closure of the present invention attached to a beverage container;

FIG. 2 is an exploded front bottom perspective view of the first embodiment of the vented closure of the present invention attached to a beverage container;

FIG. 3 is a bottom view of the first embodiment of the vented closure of the present invention attached to a beverage container;

FIG. 4 is a side cutaway view of the first embodiment of the vented closure of the present invention in the closed position attached to a beverage container;

FIG. 5 is a side cutaway view of the first embodiment of the vented closure of the present invention in the open, drinking position attached to a beverage container;

FIG. 6 is a side cutaway view of the first embodiment of the vented fluid container closure of the present invention in the intermediate “squirting” position attached to a beverage container;

FIG. 7 is a top perspective view of the second embodiment of the vented closure of the present invention in the open position attached to a beverage container;

FIG. 8 is atop perspective view of the second embodiment of the vented closure of the present invention in the closed position attached to a beverage container;

FIG. 9 is a side cutaway view of the second embodiment of the vented closure of the present invention in the closed position attached to a beverage container;

FIG. 10 is a top perspective view of the third embodiment of the vented closure of the present invention in the open position attached to a beverage container;

FIG. 11 is a top perspective view of the third embodiment of the vented closure of the present invention in the closed position attached to a beverage container;

FIG. 12 is a side cutaway view of the third embodiment of the vented closure of the present invention in the closed position attached to a beverage container;

FIG. 13 is an exploded bottom partially cutaway perspective view of the third embodiment of the vented closure of the present invention in the closed position;

FIG. 14 is a side cutaway view of the third embodiment of the vented closure of the present invention showing a resilient inert attached to a beverage container; and

FIG. 15 is a top, partially exploded perspective view of the third embodiment of the vented closure of the present invention showing a resilient insert.

### DETAILED DESCRIPTION OF THE PREFERRED EMBODIMENT

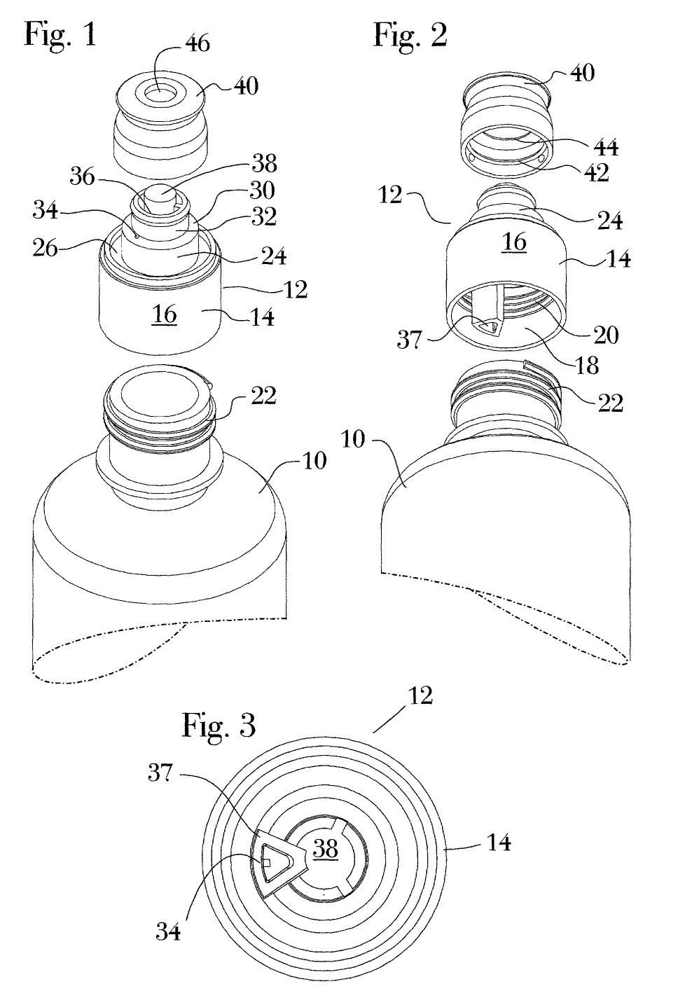

Turning first to FIGS. 1-6, the first embodiment of vented closure of the present invention can be seen. Fluid container 10, which may be any container for containing a fluid, such as a bottle for a single serving of a sport drink, is capped by vented container closure 12. The closure consists of annular collar 14, which is the preferred embodiment consists of a series of increasingly smaller-diameter connected annular rings. Collar 14 consists of first annular ring 16, which is of a first diameter and which has an internal surface 18 which comprises means for engaging with the top of the beverage container, such as threads 20, which mate with container threads 22. First ring 16 is connected to second ring 24, of a second, similar diameter via an annular shelf 26. Second ring 24 connects via tapered annular shelf 30 to third annular ring 32. Annular shelf 32 defines vent passage 34, which connects through to vent riser 37, which extends through the collar. The center of the ring 32 defines fluid passage 36. Stopper-portion 38 is connected to ring 32. The collar is preferably a one piece injected-molded material, such as high density polyethylene (HDPE) or polypropylene (PPL), but any suitable material may be used.

The closure of the first embodiment of the present invention further comprises a cap 40, which slides in a tight, frictionally-sealing sliding fit along collar 12 via annular ridges 42 and 44, which encircle the interior surface of the cap. The cap defines circular bore 46 for the passage of fluid. The cap is movable along the collar between open, intermediate, and closed positions, as will be discussed in more detail below. In the closed position the cap closes both vent passage 34 and fluid passage 36. In the intermediate position, only fluid passage 36 is open. In the open position, both passages are open. Cap 40 is preferably injection molded of low density polyethylene (-LPPE) or PPL, but any suitable material may be used.

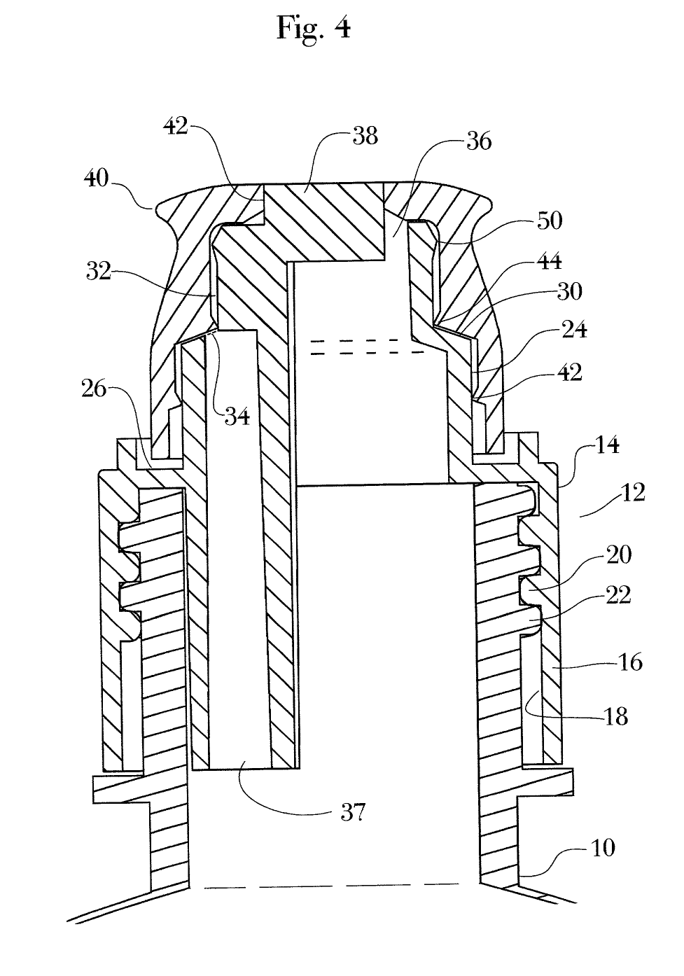

FIG. 4 shows the first embodiment of the present invention in the closed position. As can be seen, cap 40 is fully retracted down along collar 12. Bore 46 is sealed by stopper portion 38, preventing fluid flow through fluid passage 36. Vent passage 34 is sealed by ridges 42 and 44 being in tight contact with the outside surface of the collar.

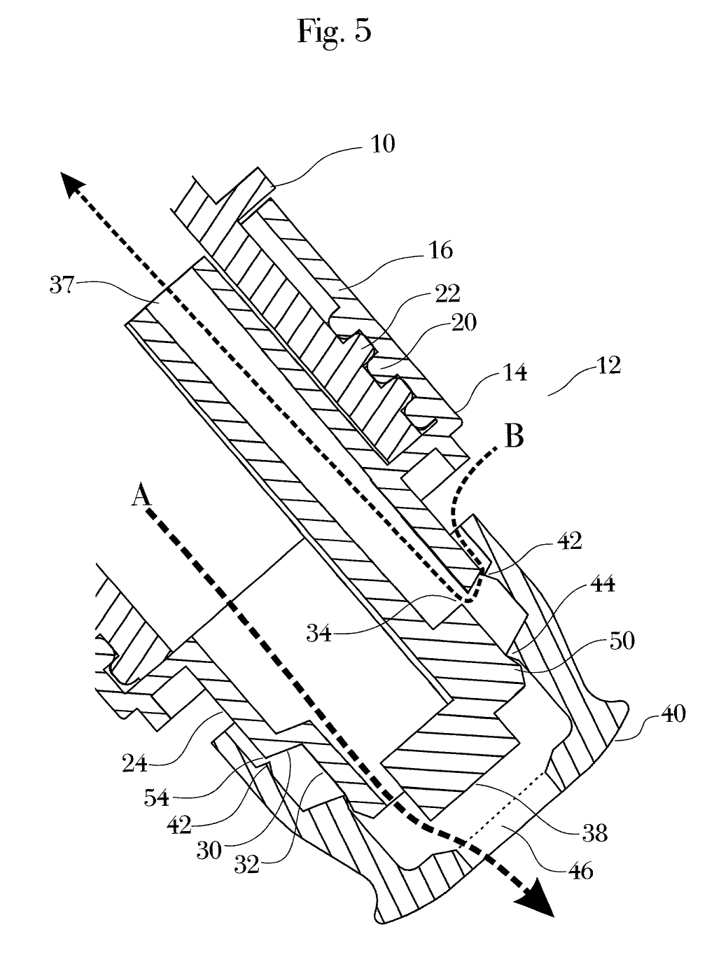

In the open position, as can be seen in FIG. 5, cap 40 is pulled outward along collar 12. Annular ridge 44 contacts stop 50 to stop any further outward time. Stopper portion 38 is withdrawn from bore 46, allowing fluid to pass through fluid passage 36 (Arrow A). Annular ridge 42 has moved beyond shoulder 54, allowing venting to occur via vent passage 34 (Arrow B). As fluid exits equally, air is drawn in via this route.

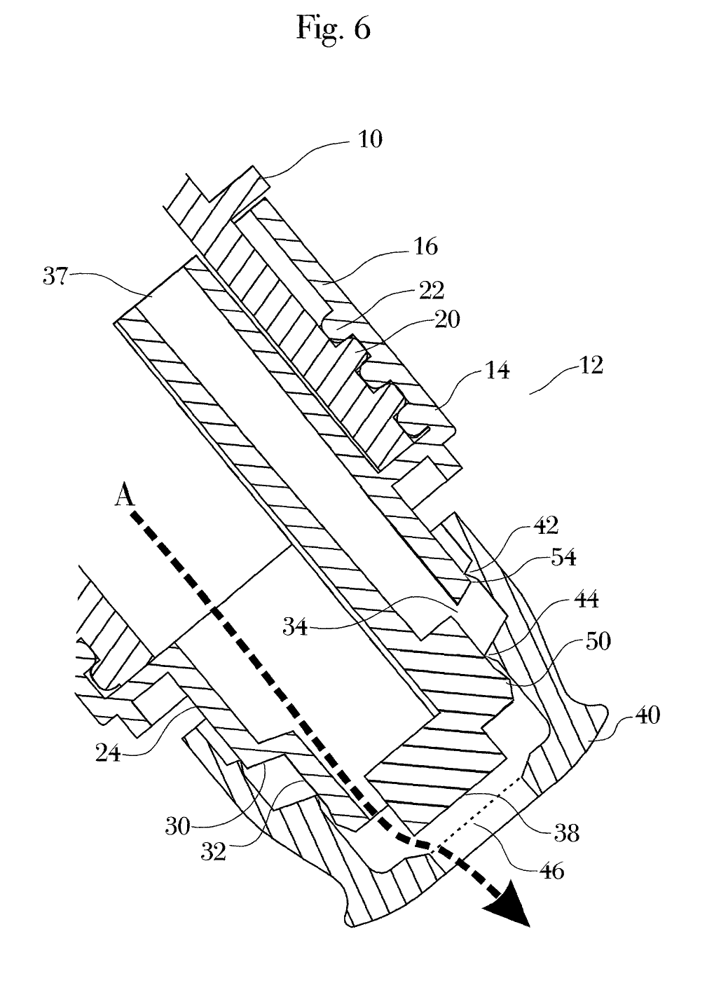

In the intermediate position (see FIG. 6), annular ring 42 is not moved beyond shoulder 54, preventing venting, but stopper portion 38 has moved sufficiently out of base 46 to allow fluid passage. (Arrow A.)

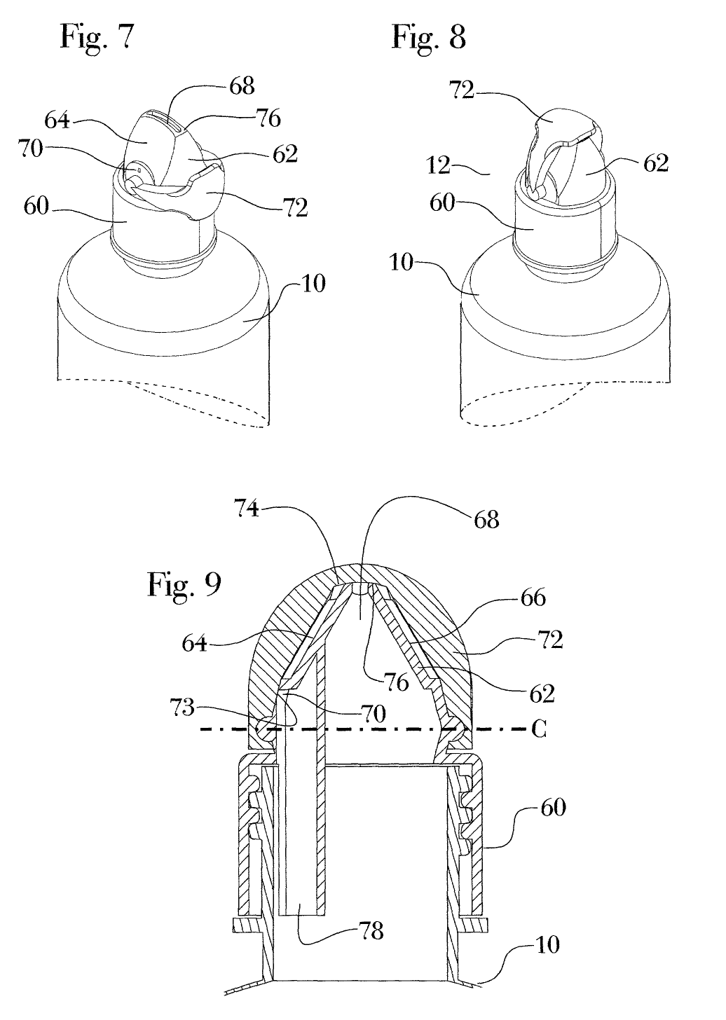

FIGS. 7 through 9 show the second embodiment of the present invention. This embodiment utilizes a rotating cap as opposed to one that slides up and down, and thus allows single hand operation of the closure. When the closure is open the fluid passage is unobstructed, allowing fluid to be drawn more easily from the container. The second embodiment consists of collar 60 connected to raised central portion 62. Central portion 62 has first and second sides 64 and 66, and defines fluid passage 68 and vent passage 70. Rotatable cap 72 which, in the particular embodiment shown, is U-shaped, but can be of any suitable shape, is connected to central portion 62. Cap 72 rotates between open and closed positions about the central portion. When closed, inner surface 74 of cap 72 closes fluid passage 68 and surface 73 of cap 72 closes vent passage 70, which connects to vent riser 78. When open the vent passage and the fluid passage perform in the same fashion as the first embodiment, to allow venting while beverage is drawn from the container. No intermediate position exists. The cap and collar are preferably of the same materials, as the first embodiment.

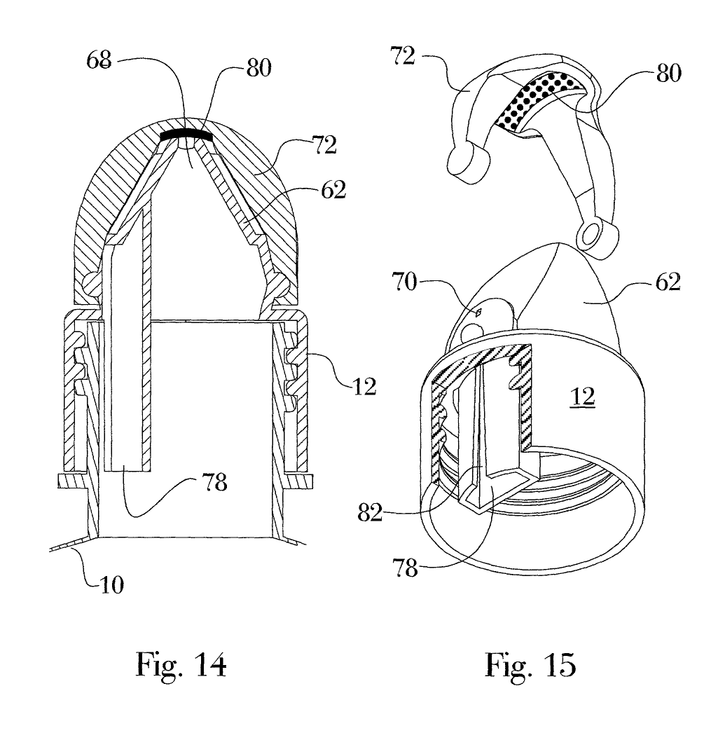

In this embodiment top surface 76 of center portion has the shape of rotation of the surface about the pivot axis, as does the bottom surface 74 of the cap, with the two surfaces shaped to fit together in a pressed sliding engagement. As can be seen, the respective center lines are lined up on the swing arm center line, (C). The U-shaped cap is sized to exert sufficient pressure on the fluid passage and vent passage when in the closed position. If desired, inserts of a resilient compliant sealing material such as food grade polyvinyl chloride (PVC) can be molded on to the inner surface of the rotating cap to effect a better seal to the vent passage and the fluid passage. (See FIGS. 14 and 15).

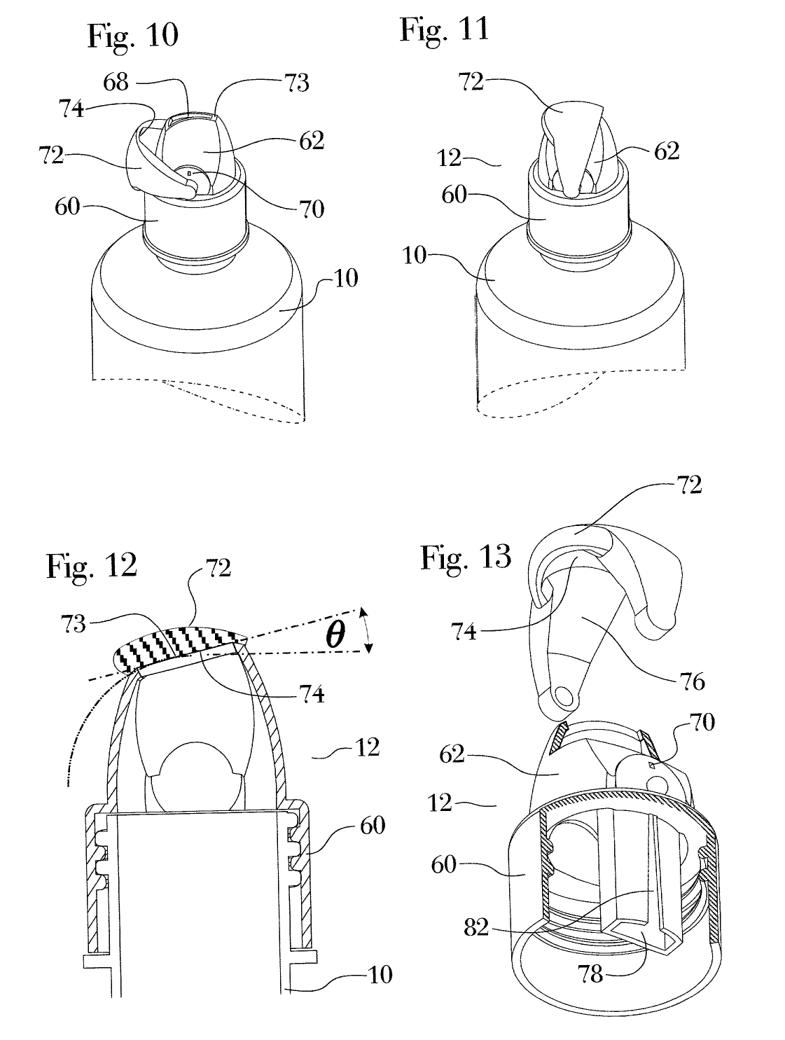

Turning to FIGS. 10-15, a third embodiment of the present invention can be seen. The third embodiment is similar to the second embodiment, but differs in the shape of the respective mating surfaces of the rotating cap and the top surface of the raised central portion. In the third embodiment these surfaces are “ramped.” As can be seen, surface 73 and corresponding inner surface 74 of the cap form an angle e from the tangent of the swing arc of between 7 and 15 degrees, causing a tight seal between the two ramped surfaces when the cap is rotated to the closed position.

FIGS. 14 and 15 show the addition of resilient insert 80 to the lower surface of the cap which can be molded on to the inner surface of the cap to permit a better seal as desired.

FIG. 15 also shows a vent riser 78 that is modified from that shown in the first embodiment. As can be seen, riser 78 has been split via groove 82 to form a “C” shape. Eliminating a portion of the wall of the riser in this fashion allows the riser to be molded further from the center of the closure, and therefore further from the mouth contact area, preventing the vent from being obstructed by the consumer's lips and simplifying molding.

The present invention has been described in an illustrative manner. It should be understood and evident that modifications may be made to the specific embodiment shown herein without departing from the spirit and scope of the present invention. Such modifications are considered to be within the scope of the present invention, when it is limited solely by the scope and spirit of the appended claims.

I claim:

1. A closure for a fluid container comprising:
an annular collar;
a cap having an annular interior surface, said cap engaging said collar and movable between an open and closed position along said collar;
said collar defining a fluid passage;
said collar defining a vent passage;
whereby when said cap is in the open position said fluid passage and said vent passage are open and when said cap is in the closed position said fluid passage and said vent passage are closed.

2. The closure of claim 1 wherein said cap is capable of being moved to an intermediate position along said collar such that when said cap is in said intermediate position said fluid passage is open and said vent passage is closed.

3. The closure of claim 1 wherein said collar comprises a vent riser connecting to said vent passage.

4. The closure of claim 1 wherein said cap comprises a fluid bore and said collar comprises a stopper portion, said bore engaged by said stopper when said cap is in the closed position.

5. The closure of claim 1 where said cap comprises a plurality of annular ridges on said interior surface.

6. The closure of claim 1 wherein:
said cap is capable of being moved to an intermediate position along said collar such that when said cap is in said intermediate position said fluid passage is open and said vent passage is closed; and
said cap comprising at least two annular ridges such that in said intermediate position one of said ridge prevents the passage of air through said vent passage.

7. A closure for a fluid container comprising:
an annular collar;
said collar comprising:
a first substantially annular ring of a first diameter for engagement of said container;
a second substantially annular ring of a second diameter, said second diameter smaller than said first diameter, said second ring connected to said first ring via an annular shelf,
a third substantially annular ring of a third diameter, said third diameter smaller than said second diameter, said third ring connected to said second ring by a tapered shelf, and said third ring defining a fluid passage and said tapered shelf defining a vent passage;
a cap; said cap movable along said collar between an open position and a closed position; said cap closing both said vent passage and said fluid passage when said cap is in said closed position.

8. The closure of claim 7 where said annular shelf further comprises a raised ring for receiving said cap.

9. The closure of claim 7 wherein said collar further comprises a stopper portion connected to said third ring.

10. The closure of claim 7 wherein said cap further comprises an inner annular surface with at least one annular ridge on said surface for sealing said closure when said cap is in the closed position.

11. The closure of claim 7 wherein said collar further comprises a stopper portion connected to said third ring and said cap defines a bore, said stopper portion engaging said bore when said cap is in the closed position.

12. The closure of claim 7 wherein said collar comprises a vent riser connecting to said vent passage.

13. The closure of claim 7 wherein said cap is capable of being moved to an intermediate position along said collar such that when said cap is in said intermediate position said fluid passage is open and said vent passage is closed.

14. The closure of claim 7 wherein said cap is capable of being moved to an intermediate position along said collar such that when said cap is in said intermediate position said fluid passage is open and said vent passage is closed; and
said cap comprises at least one annular ridge such that in said intermediate position said ridge prevents the passage of air through said vent passage.

15. A closure for a fluid container comprising:
an annular collar for engagement with the top of a container;
a raised central portion with a first and second sides connected to and extending above said collar, said portion defining a fluid passage and a vent passage;
a rotatable cap connected to said central portion;
said cap rotatably operable between an open position and a closed position, said fluid passage and said vent passage being closed when said cap is in the closed position.

16. The closure of claim 15 wherein said vent passage is defined by one of said sides of said raised portion.

17. The closure of claim 15 further comprising a resilient insert attached to said cap for closing said fluid passage when said cap is in the closed position.

18. The closure of claim 15 further comprising a vent riser connecting to said vent passage.

19. The closure of claim 15 wherein said collar has a top surface which has the shape of rotation of the cap about the pivoted axis and said rotatable cap has a lower surface which has the shape of rotation of the cap about the pivotal axis.

20. The closure of claim 15 wherein said collar has a top surface which is angled and said rotatable cap has a closure which is angled.
